(19) United States
(12) Patent Application Publication
(10) Pub. No.: US 2002/0185823 A1
(43) Pub. Date: Dec. 12, 2002

(54) Fitting

(75) Inventor: Heinz Graber, Oberkulm (CH)

Correspondence Address: OLIFF & BERRIDGE, PLC, P.O. BOX 19928, ALEXANDRIA, VA, 22320, US

(73) Assignee: KWC AG, Unterkulm (CH)

(21) Appl. No.: 10/158,832

(22) Filed: Jun. 3, 2002

(30) Foreign Application Priority Data
Jun. 8, 2001 (CH) 2001 1042/01

(51) Int. Cl. F16L 17/025

(52) U.S. Cl. 277/626

(57) ABSTRACT

A fitting having a discharging connection, a basic body and a discharging part which is connected rotatably to the basic body. An intermediate part is arranged between the basic body and the discharging part, the intermediate part having at least one opening for the outlet of water from the basic body into the discharging connection and against which the discharging part is supported, at least in the region above and below the opening. At least one seal runs in the circumferential direction and is arranged between the intermediate part and the basic body and between the intermediate part and the discharging part.

### BACKGROUND OF THE INVENTION

1. Field of Invention

The invention relates to a fitting having a basic body and a discharging part connected rotatably thereto, and a discharging connector. The fitting comprising an intermediate part which is arranged between the basic body and discharging part and has at least one opening for the outlet of water from the basic body into the discharging connection and against which the discharging part is supported with at least one seal running in the circumferential direction between the intermediate part and the basic body and between the intermediate part and the discharging part.

2. Description of Related Art

In general, fittings comprise a basic body and a discharging part which is connected rotatably to the basic body in order to direct the emerging jet of water in a desired direction. A mixing cartridge can be accommodated in the basic body and can be used to set the desired quantity and temperature of the emerging water. The quantity and temperature of the water are selected via an actuating lever which is connected to the basic body or to the mixing cartridge. The parts which can be moved with respect to each other—the basic body and discharging part—have to be sealed with respect to each other in such a manner that water cannot emerge between the basic body and discharging part. Furthermore, the connection has also to be sealed against dirt penetrating from outside. At the same time, the ability of the discharging part to slide relative to the basic body is to be retained, even when used for a relatively long time.

In the case of known fittings, the discharging part slides directly on the basic body, an O-ring seal being present in each case between the basic body and the discharging part so as to provide a seal above and below a discharging opening for water in the basic body. The problem here is that the region between the basic body and that shoulder of the discharging part which is on the basic body side can often not be sealed completely. Residues therefore penetrate into this part, said residues leading to deposits and adversely affecting the sliding of the parts on one another. In particular, furring is a problem.

### SUMMARY OF THE INVENTION

The invention is therefore based on the object of providing a fitting in which the seal and slideability between the basic body and discharging part are improved and a long use is also ensured.

The object is achieved by a fitting having a basic body and a discharging part connected rotatably thereto, and a discharging connector. The fitting comprising an intermediate part which is arranged between the basic body and discharging part and has at least one opening for the outlet of water from the basic body into the discharging connection and against which the discharging part is supported with at least one seal running in the circumferential direction between the intermediate part and the basic body and between the intermediate part and the discharging part.

According to the invention, an intermediate part is arranged between the basic body and the discharging part connected rotatably thereto. Said intermediate part is placed in a sleeve-like manner around the basic body and has at least one opening for the outlet of water from the basic body and as a passage to the discharging connection. Seals are situated both between the intermediate part and the basic body and between the intermediate part and the discharging part. The intermediate part, which is preferably manufactured from plastic, enables the friction between the conventionally metallic elements—the basic body and discharging part—to be considerably reduced. The intermediate part also has the advantage that the seals between the intermediate part and basic body, on the one hand, and between the intermediate part and discharging part, on the other hand, can be arranged at the same height, in particular in annular grooves in the basic body and discharging part. The seals arranged in such a manner press in mutually opposite directions onto the intermediate part, as a result of which the latter is stabilized. The intermediate part does not therefore tilt under the tensile load exerted by the discharging part, and no gaps are formed between the components. The seals are preferably arranged in this manner, at least at a height below the discharging opening.

In order to stabilize the discharging part against being displaced in the direction of the longitudinal axis of the basic body and in order to prevent the basic body and discharging part from becoming wedged, the basic body preferably has a horizontally extending edge on which a likewise horizontally extending edge on the lower shoulder of the discharging part is supported. A horizontal sliding disk which preferably consists of plastic is preferably situated in the region between these edges.

In a preferred design of the invention, at least some of the seals are dynamic seals, in particular lip seals arranged in grooves, which are situated between the basic body and intermediate part. The discharging part comprises a sleeve, which is placed around the basic body and intermediate part, and a discharging connection fitted thereto. At least one statically used O-ring seal is preferably situated between the intermediate part and the discharging part. The discharging part preferably has, in the region of the discharging connection, material, for example a transversely extending web, by which it is supported against the intermediate part. The seal is preferably arranged level with this material between the intermediate part and basic body, with the result that the material can form a counterpressure for sealing purposes and can additionally stabilize the intermediate part.

The invention makes it possible for the basic body, intermediate part and discharging part to lie tightly against one another in the region of the outlet opening for water, so that no gaps are formed in which residues may become deposited. The slideability is therefore retained, even over a prolonged period of use.

### BRIEF DESCRIPTION OF THE DRAWINGS

Embodiments of the invention are illustrated in the drawing and are described below. In the drawing, purely schematically:

FIG. 1 shows a section through a fitting according to the invention;

FIG. 2 shows a view along the section line I-I from FIG. 1;

FIG. 3 shows an intermediate part according to the invention;

FIGS. 4a,b show a subsection of a ring seal according to the invention.

### DETAILED DESCRIPTION OF PREFERRED EMBODIMENTS

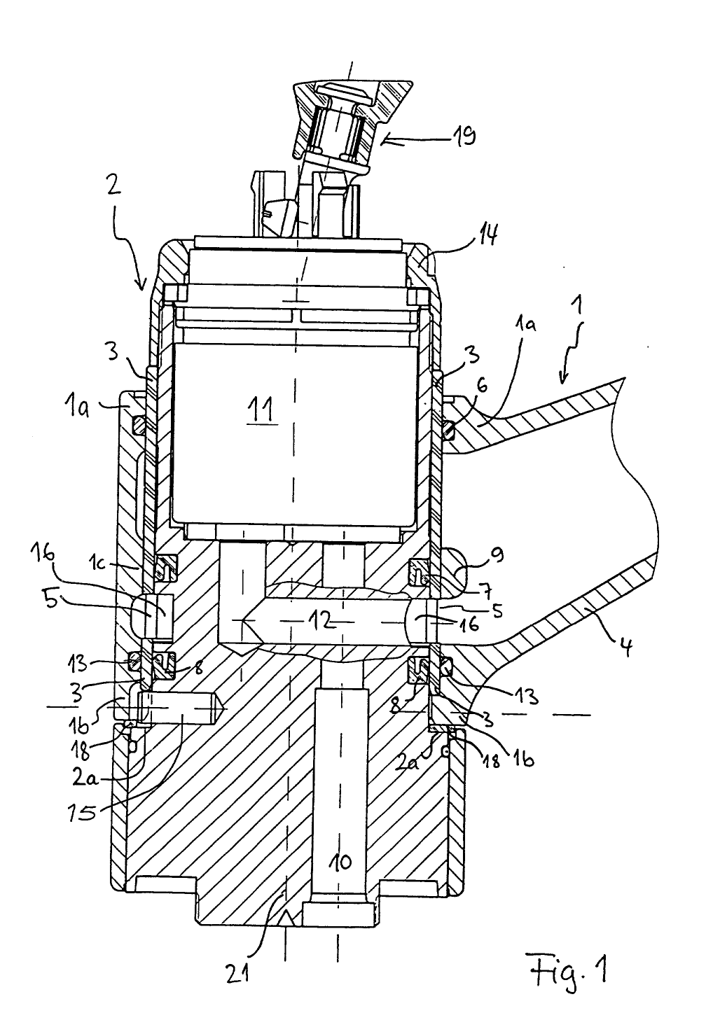

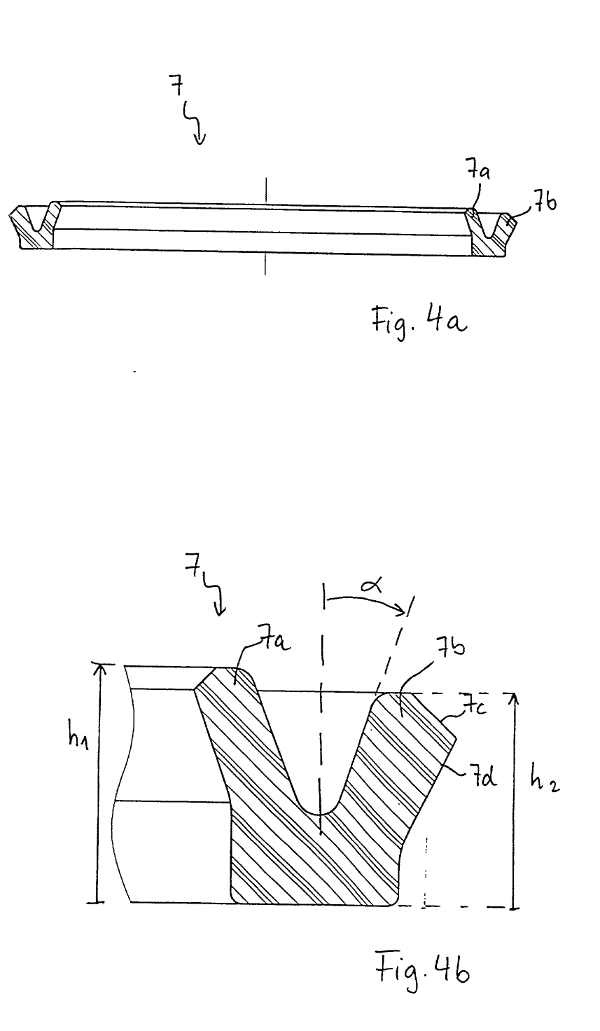

FIG. 1 shows a view of a fitting according to the invention in the section along the longitudinal axis 21 of the basic body 2. The basic body 2 contains a mixing cartridge 11 which is supplied with hot and cold water via water feeds 10, of which only one can be seen here. Water of a temperature and quantity set via an actuating lever, of which only the coupling piece 19 is illustrated, leaves the mixing cartridge via a water outflow 12 which opens into an annular groove 16, which runs in the circumferential direction, in the basic body 2. An intermediate part 3 in the form of a cylindrical sleeve is arranged coaxially with the basic body 2. Said sleeve is provided in the lower region with openings 5 for discharging the water into the discharging connection 4 of a discharging part 1. The discharging part 1 is likewise arranged coaxially with the basic body 2 and intermediate part 3 and can rotate about the longitudinal axis 21. This enables the discharging connection 4 to change its orientation in space. The intermediate part 3 is therefore fixed in the radial direction by the basic body 2 and discharging part 1. In the axial direction, the lower shoulder 1b of the discharging part rests on a horizontally extending edge 2a of the basic body or on a sliding disk 18 resting thereon. The lower shoulder 1b furthermore forms a horizontal stop for the intermediate part 3. The intermediate part 3 is finally likewise fixed in the axial direction by a union nut 14 which is placed onto the basic body 2 with the mixing cartridge 11. A cap, which is not illustrated here and also fixes the discharging part 1 in the axial direction, is placed onto the entire arrangement. A dynamic seal 7, 8 is situated in a respective groove above and below the annular groove 16. Said seal contains an annular sealing element which is illustrated in greater detail and described in FIGS. 4a, b. These seals 7, 8 seal the region between the basic body 2 and intermediate part 3 against the penetration of water. Since there is no gap between the basic body 2 and intermediate part 3 in the region of the annular groove 16 and the outlet opening 5 of the intermediate part, the risk of deposits in this region is small. The formation of a gap is additionally prevented by the counterpressure of the lower shoulder 1b of the discharging part and of the O-ring seal arranged in this region. Said seal stabilizes the intermediate part 3 against the outwardly directed pressure of the dynamic seal 8. In the region above the annular groove 16 or the outlet opening 5, the intermediate part 3 is stabilized by the web within the discharging connection 4, which web bears in this region against the intermediate part 3 and stabilizes the latter against the outwardly directed pressure of the dynamic seal 7.

In the region of the upper shoulder 1a of the discharging part 1, a further seal 6 is arranged in a groove between the discharging part 1 and intermediate part 3. In addition, in the region of the lower shoulder 1b of the discharging part 1, a further seal 13 may be arranged in a groove between the discharging part 1 and intermediate part 3. The seals prevents both the penetration of dirt from outside and also the escape of water from inside.

In order to further reduce the friction between the basic body 2 and intermediate part 3, lip seals 8 take on the sealing function. The intermediate part 3 is connected to the discharging part as carrier by the static seals 6 and 13.

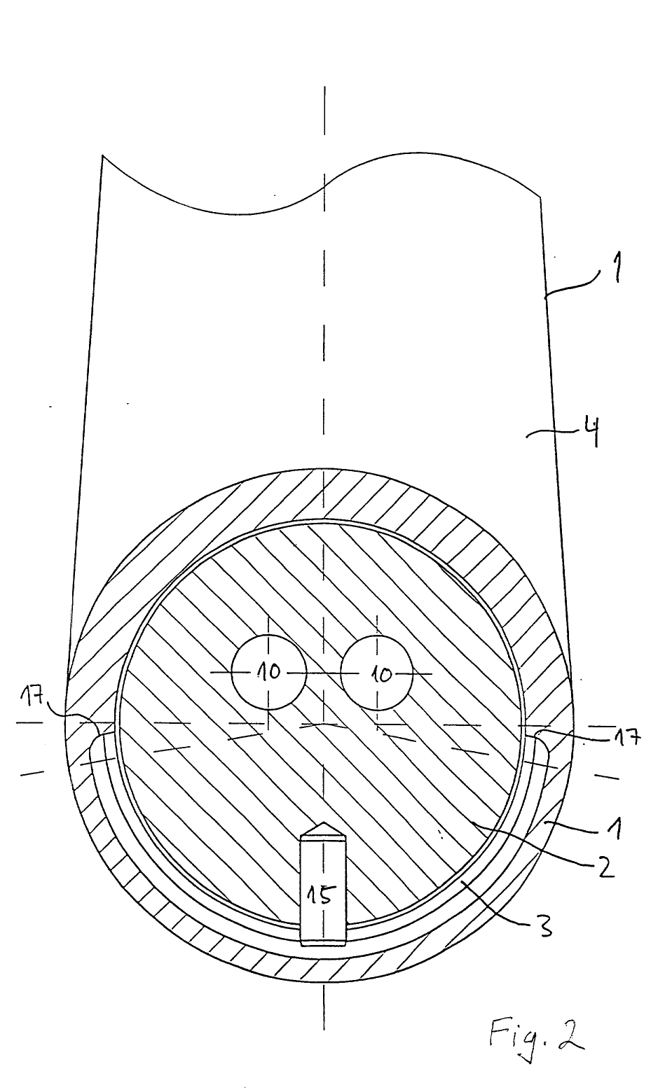

In order for it to be possible for the discharging connection 4 only to pivot within a certain region, a stop pin 15 is arranged in the basic body, which stop pin interacts with a counterstop 17 of the discharging part 1 (see FIG. 2).

FIG. 2 shows a view along the line I-I from FIG. 1. The basic body 2 has a circular cross section. The intermediate part 3, only part of which can be seen here, is arranged coaxially therewith. The discharging part 1 is likewise arranged coaxially therewith, said discharging part having, in the region facing away from the discharging connection 4, a cutout, the edges of which form counterstops 17 for the stop pin 15. In this manner, the pivoting region of the discharging connection 4 is defined. Two water feeds 10 for hot and cold water are likewise illustrated.

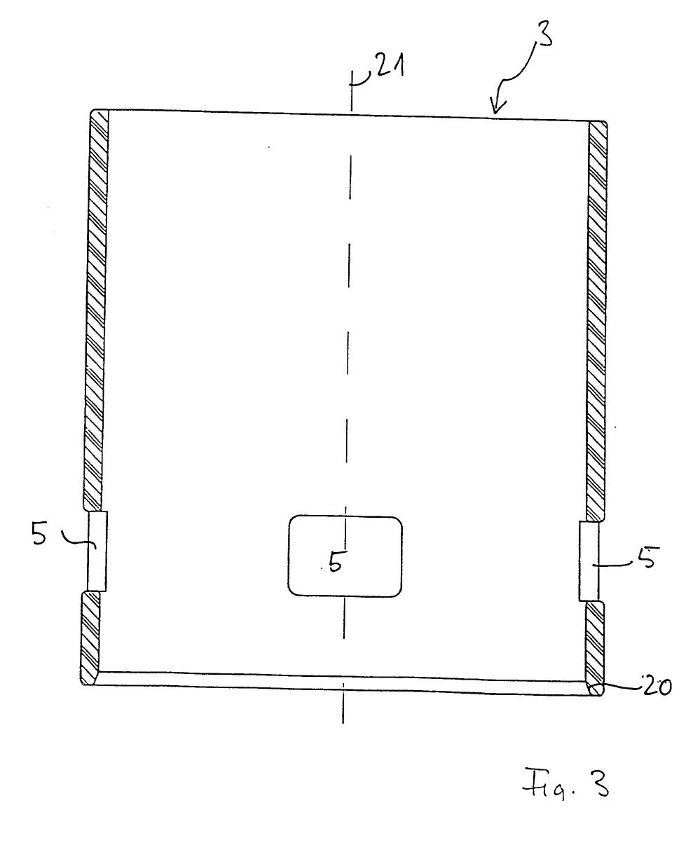

FIG. 3 shows a partially cutaway view of the intermediate part 3. The intermediate part 3 is a cylindrical sleeve arranged concentrically with the longitudinal axis 21 of the basic body 2. Said sleeve has, in the lower region, openings 5 which are distributed uniformly in the circumferential direction. They are arranged in such a manner that the same quantity of water can always emerge from the basic body with the intermediate part irrespective of the position of the discharging connection. The lower edge of the intermediate part 3 has an inwardly directed bevel 20 which facilitates the installation. Said bevel interacts with a correspondingly beveled surface of the seals 7, 8 and pushes the latter into their grooves as the intermediate part is being plugged on.

FIG. 4 shows a sealing element according to the invention for a dynamic seal. It comprises a ring consisting of elastic material with a V-shaped cross section. The one leg 7a has a height Hi which is greater than the height H2 of the other leg 7b. In the case of application, the longer leg 7a is spaced further away from the opening to be sealed than the shorter leg 7b. The two legs 7a, 7b enclose an opening angle 2α which is approximately 40°. In the case of application, the two legs are bent in an approximately parallel position. This can be seen in FIG. 1 where the seals 7, 8 are essentially U-shaped in cross section. In order to be able to slide the intermediate part 3 on the basic body 2 past the seals 7, 8, the second leg 7b has oblique surfaces 7c, 7d. The leg 7b is therefore pushed in the direction of the other leg 7a irrespective of the orientation of the seal.

Rubber is used as the material, for the appropriate quality of water.

What is claimed is:

1. A fitting having a basic body and a discharging part which is connected rotatably thereto and has a discharging connection, the fitting comprising:
an intermediate part arranged between the basic body and the discharging part and having at least one opening for fluid flow from the basic body to the discharging connection, the discharging part being supported against the intermediate part at least in a region above and below the opening; and
at least one seal running in a circumferential direction and arranged between the intermediate part and the basic body and at least one seal running in a circumferential direction and arranged between the intermediate part and the discharging part.

2. The fitting as claimed in claim 1, comprising the at least one seal arranged between the intermediate part and the basic body above the opening, and at least one seal arranged between the intermediate part and the basic body below the opening.

3. The fitting as claimed in claim 1, wherein the at least one seal arranged between the intermediate part and the basic body is a dynamic seal.

4. The fitting as claimed in claim 1, comprising the at least one seal arranged between the intermediate part and the discharging part between the intermediate part and an upper shoulder of the discharging part and at least one seal arranged between the intermediate part and the discharging part between the intermediate part and the lower shoulder of the discharging part.

5. The fitting as claimed in claim 1, wherein the at least one seal arranged between the intermediate part and the discharging part is a static seal.

6. The fitting as claimed in claim 1, wherein the discharging part has a web which bears against the intermediate part and is adjacent to the at least one opening in the intermediate part in an axial direction.

7. The fitting as claimed in claim 6, wherein the at least one seal arranged between the intermediate part and the basic body is level with the web.

8. The fitting as claimed in claim 1, wherein the intermediate part has a plurality of openings which are arranged at a regular interval in the circumferential direction.

9. The fitting as claimed in claim 1, wherein at least one stop pin is arranged on the basic body and limits a pivoting movement of the discharging part.

10. The fitting as claimed in claim 9, wherein a lower shoulder of the discharging part supports the discharging part directly against the basic body and forms a counterstop for the at least one stop pin.

11. The fitting as claimed in claim 1, wherein the at least one seal arranged between the intermediate part and the basic body is a lip seal which is V-shaped in cross section and consists of an elastic material, a leg of the V-shaped lip seal facing a point to be sealed and being shorter than another leg of the V-shaped lip seal.

12. The fitting as claimed in claim 1, wherein a horizontal sliding disk is arranged between the basic body and discharging part.

13. The fitting as claimed in claim 1, wherein the at least one seal arranged between the intermediate part and the discharging part is a lip seal which is V-shaped in cross section and consists of an elastic material, a leg of the V-shaped lip seal facing a point to be sealed and being shorter than another leg of the V-shaped lip seal.

14. The fitting as claimed in claim 3, wherein the at least one seal arranged between the intermediate part and the basic body is a lip seal arranged in a groove in the basic body.

15. The fitting as claimed in claim 5, wherein the at least one seal arranged between the intermediate part and the discharging part is an O-ring seal arranged in a groove in the discharging part.
